(19) United States
(12) Patent Application Publication
(10) Pub. No.: US 2019/0294625 A1
(43) Pub. Date: Sep. 26, 2019

(54) MEDIA-CONNECTING DEVICE TO CONNECT PRINTED MEDIA TO NON-STATIC DIGITAL MEDIA

(71) Applicant: CHATBOOKS, INC., Provo, UT (US)

(72) Inventor: Steven Michael Bentz, Orem, UT (US)

(21) Appl. No.: 16/360,881

(22) Filed: Mar. 21, 2019

Related U.S. Application Data
(60) Provisional application No. 62/647,029, filed on Mar. 23, 2018.

(51) Int. Cl. G06F 16/438; H04W 4/80; G06K 7/10; G06F 16/432; G06K 7/14

(52) U.S. Cl. CPC G06F 16/4393; H04W 4/80; G06K 7/1417; G06F 16/434; G06K 7/10237

(57) ABSTRACT

An electronic device includes a tag reader device and a central processing unit (CPU) coupled to the tag reader device. The tag reader device to read a unique identifier (UID) from an asset tag coupled to a printed product. The CPU is to send a request with the UID to a server over a network connection. The CPU is further to receive, from the server over the network connection, a response comprising non-static digital media associated with the UID. The CPU is further to cause the non-static digital media to be presented via a display.

### RELATED APPLICATION

This application claims the benefit of Provisional Application No. 62/647,029, filed Mar. 23, 2018, the entire content of which is hereby incorporated by reference.

### BACKGROUND

Image capturing devices have become smaller and more readily available. A user often has easy access to one or more image capturing devices, such as a camera or a computing device (e.g., smartphone, tablet, laptop, computer, etc.) that includes or is coupled to a camera. A user can use an image capturing device to capture static media such as photographs (photos) and dynamic media such as live photos, videos, and so forth. A user can desire to share or remember one or more events through a combination of static media and non-static digital media.

Printed media (e.g., printed products such as a photo books, photo albums, scrapbooks, prints, printed and products) can provide curation of photos and other types of printed material. Printed media is limited to static images. Videos and other types of non-static digital media may not be enjoyed using printed media.

### BRIEF DESCRIPTION OF DRAWINGS

The present disclosure will be understood more fully from the detailed description given below and from the accompanying drawings of various embodiments, which, however, should not be taken to limit the present disclosure to the specific embodiments, but are for explanation and understanding only.

FIG. 1 is a block diagram of a system including a media-connecting device coupled to a display, according to certain embodiments.

FIG. 2 is a flow diagram of a method for using a media-connecting device with printed media for playback of non-static digital media, according to certain embodiments.

FIG. 3 is a block diagram of a system including a media-connecting device and a streaming device, according to certain embodiments.

FIGS. 4-5 are flow diagrams of methods for using a media-connecting device with printed media for playback of non-static digital media, according to certain embodiments.

FIG. 6 is a block diagram of a system including tag-associating device, according to certain embodiments.

FIG. 7 is a flow diagram of a method for using a tag-associating device to associate an identifier of an asset tag with non-static digital media, according to certain embodiments.

FIG. 8 illustrates a diagrammatic representation of a machine in the example form of a computer system, according to certain embodiments.

### DETAILED DESCRIPTION

A media-connecting device to connect printed media to digital media, including non-static digital media, is described. Given the easy access to image capturing devices, users often have a multitude of digital media including static media (e.g., photos) and non-static digital media (e.g., videos, live photos). Static media can be printed to be viewed in different forms of printed media, such as photo books, photo prints, scrapbooks, etc. While static media can be printed in printed media, conventionally printed media does not display dynamic media. Non-static digital media, as used herein, is any digital media that contains moving pictures, video, audio, live photos, dynamic images, graphics interchange format (GIF), multiple static images in a presentation, multi-media content, rich media, and the like. To find non-static digital media associated with printed media, a user can browse, search, and curate the multitude of digital media, which can be very time consuming and error prone. Browsing, searching, and curating digital media can also be associated with increased processor overhead, energy consumption, and required bandwidth.

Subsets of digital media can be stored on physical storage, such as compact discs (CDs), digital versatile discs (DVDs), digital optical discs (e.g., Blu-ray® disc) and universal serial bus (USB™) devices, etc. To view the digital media stored in the physical storage, the physical storage is to be loaded into or connected to a computing device. The digital media stored in physical storage can quickly become outdated (e.g., has a limited lifetime) and may not be tailored to current interests of a user.

Aspects of the present disclosure address the deficiencies of conventional systems by providing a media-connecting device to connect printed media with digital media, including static and non-static digital media. The media-connecting device can include a tag reader device (e.g., radio-frequency identification (RFID) reader device, near-field communication (NFC) reader) and a central processing unit (CPU) coupled to the tag reader device. Printed media (e.g., photo book, printed photos, etc.) can be associated with digital media (e.g., static digital media, non-static digital media) managed by a server. For example, when the printed media is printed, an identifier can be assigned to a particular printed media product and the identifier is associated with specific digital media (or identifiers of specific digital media) in a data store, such as a database. The identifier can be associated with an asset tag coupled to the printed media. For example, an NFC sticker can be attached to (e.g., embedded in, placed on, placed behind, etc.) the printed media and an identifier can be associated with the NFC sticker. The tag reader device of the media-connecting device can read the identifier from the asset tag coupled to the printed media. The CPU can transmit the identifier to the server to cause the server to retrieve digital media associated with the identifier. The CPU can receive the digital media from the server and can cause the digital media to be presented via a display (e.g., television, monitor).

For example, an NFC sticker can be attached to a photo book and the media-connecting device can be a dongle that can inserted into a port of a television, such as a high-definition multimedia interface (HDMI) socket. By tapping the NFC sticker on the photo book on the dongle or bringing the photo book within a threshold distance of the dongle, the RFID reader of the dongle can receive the UID from the NFC sticker, transmit the UID to the server, receive digital media from the UID, and cause the television to display the digital media (e.g., videos, slideshow, etc.) associated with the photo book. It should be noted that the digital media retrieved can be the static images in the photo book, additional static images, or non-static digital media that is associated with the printed images in the photo book.

Digital media, including static digital media and non-static digital media, can be uploaded to the server. A subset of the static media can be selected and published in printed media (e.g., a photo book including photos from a period of time, event, and/or location). In some embodiments, the printed media can be produced with a first asset tag (e.g., NFC sticker) and a second asset tag (e.g., a barcode) on the printed media. For example, during printing, a barcode can be printed on the printed media and after printing, an NFC sticker can be applied to the printed media. The second identifier of the second asset tag (e.g., barcode) is assigned to the printed media and specific digital media (or identifiers of specific digital media) in a data store, such as a database.

A tag-associating device can include a first tag reader device (e.g., NFC tag reader device, RFID tag reader device), a second tag reader device (e.g., barcode reader device, optical tag reader device), and a CPU. The first tag reader device can read a first identifier from the first asset tag (e.g., read a UID from the NFC sticker that is not associated with digital media) and the second tag reader device can read a second identifier from the second asset tag (e.g., an identifier from the barcode that is associated with digital media). The tag-associating device can send the first and second identifiers to the server to associate the first identifier with the digital media. Subsequent to being associated, a media-connecting device can transmit the first identifier (e.g., associated with an NFC sticker attached to printed media) to the server and receive digital media associated with the printed media for presentation.

For example, a photo book can be printed with a barcode that can be optically scanned to cause digital media associated with the photo book to be presented. An NFC sticker can be applied to the photo book, where the NFC sticker is not associated with digital media. A tag-associating device can be used to read a first identifier from the NFC sticker, read a second identifier from the barcode, and send the first and second identifiers to the server so that the first identifier of the NFC sticker is also associated with the same digital media with which the second identifier of the barcode is associated. Subsequently, the photo book can be tapped on or brought within a threshold distance of a dongle (e.g., media-connecting device) to cause the digital media to be presented on a display.

In some embodiments, the CPU of the device can provide the identifier associated with an asset tag to a streaming device and the streaming device can provide the identifier to the server for retrieval of digital media for presentation via a display. In some embodiments, the CPU can provide the identifier associated with an asset tag to the server and the server can provide the digital data to a streaming device for presentation via a display.

Aspects of the present disclosure address the deficiencies of conventional systems. The present disclosure connects printed media with playback of digital media, whereas conventional approaches do not link printed and digital media. By using an identifier of an asset tag coupled to printed media, the device of the present disclosure can receive and provide playback of associated digital media without browsing, searching and curating digital media which can be time consuming and error prone. By using an identifier of an asset tag coupled to the printed media, the device of the present disclosure can receive and provide playback of a presentation of associated digital media without manual browsing, searching, and generation of the presentation which is time consuming and error prone. By using an identifier of an asset tag coupled to the printed media, the device of the present disclosure can receive and provide playback of associated digital media that is current and suited to interests of a user instead of using non-current media in a physical media storage that is not tailored to current interests of the user.

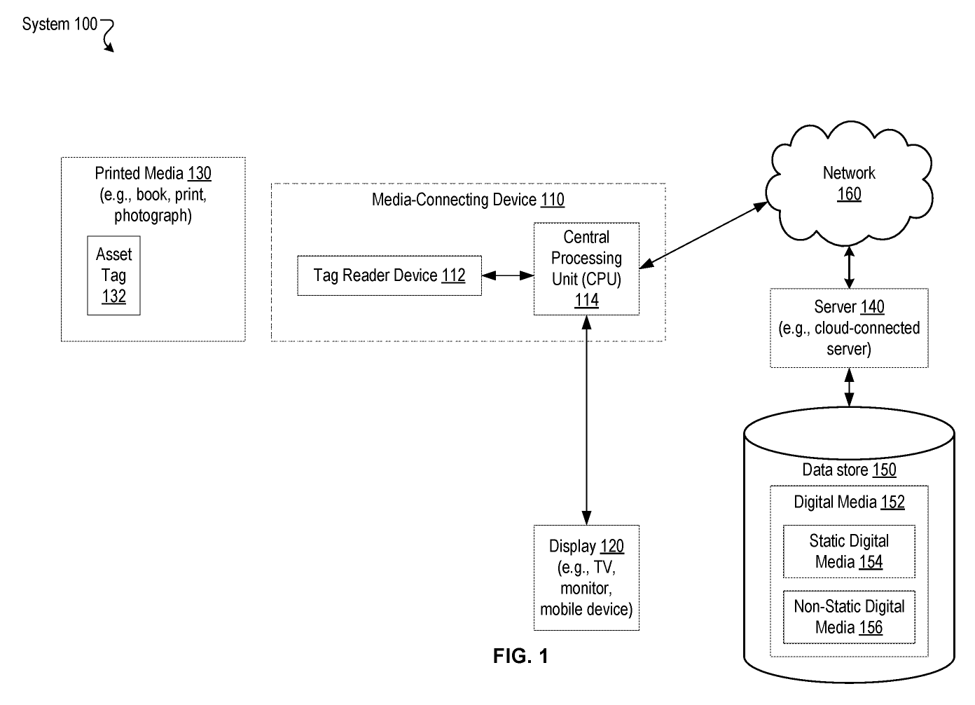

FIG. 1 is a block diagram of a system 100 including a media-associating device 110 (e.g., electronic device) coupled to a display 120, according to certain embodiments.

In some embodiments, the media-associating device 110 is an adaptor, peripheral appliance, Internet-of-Things (IoT) device, and/or dongle that plugs into a computing device (e.g., games console, television, set-top-box, media player, personal computer (PC), laptop, display 120, etc.) to provide functionality. For example, media-associating device 110 can be a dongle that plugs into a USB™ or HDMI port of display 120 (e.g., a television, monitor, etc.).

The media-associating device 110 can include a tag reader device 112 (e.g., NFC reader device, RFID reader device, etc.). The tag reader device 112 can use electromagnetic fields (e.g., via an RFID technology) to automatically identify and track tags (e.g., NFC stickers) attached to objects (e.g., printed media). In some embodiments, the present disclosure can identify and track tags using one or more types of technologies, such as active RFID, passive RFID, ultra-wideband (UWB) real-time location system (RTLS), WiFi RTLS, infrared RTLS, etc. The tag reader device 112 can be a device with an antenna that is capable of reading asset tags 132 (e.g., NFC stickers) (e.g., via NFC communication protocols) within a threshold range (e.g., 4 centimeters (1.6 inches)). The NFC communication protocols can enable two devices (e.g., media-associating device 110 and asset tag 132) to establish communication by bringing them within a threshold distance of each other. At least one of the devices in the NFC communication can be a portable device such as a smartphone, tablet, laptop, dongle, etc.

The media-associating device 110 can include a CPU 114 (e.g., processing device). The CPU 114 can be a processing device capable of communicating with the tag reader device 112, communicating with the server 140 via the network 160, and causing digital media 152 (e.g., non-static digital media 156) to be presented for playback via display 120. The CPU 114 can respond to input from an input device including remote controls and/or mobile devices. In some embodiments, the media-associating device 110 is a mobile device (e.g., the mobile device includes the tag reader device 112 and the CPU 114). In some embodiments, tag reader device 112 and CPU 114 are integral to the same media-associating. In some embodiments, tag reader device 112 and CPU 114 are part of separate (e.g., disparate) devices.

The CPU 114 can receive an identifier (e.g., unique identifier (UID)) associated with an asset tag 132 of printed media 130, provide the identifier to server 140 via network 160, receive digital media 152 corresponding to the identifier from the server 140 via the network, and cause the digital media 152 to be presented via the display 120. In some embodiments, the CPU 114 processes the digital media 152 to be presented via the display 120. For example, the CPU 114 can prepare a presentation based on the digital media 152, the CPU 114 can crop one or more of the digital media 152, the CPU 114 can adjust the playback (e.g., speed, order, audio, captions, transitions, etc.) of one or more of the digital media 152, etc. The CPU 114 can cause the digital media 152 to be stored in local storage of the media-associating device 110.

The display 120 can be a display device that includes one or more of a television (e.g., TV), monitor, mobile device, screen, etc. The display 120 can be configured to display digital media 152, static digital media 154 (e.g., photos), non-static digital media 156 (e.g., videos, media with metadata, media that varies over time), processed media (e.g., presentations, etc.), and so forth.

The system 100 can include printed media 130. The printed media can be a photo book, printed photos, scrapbook, etc. An asset tag 132 that is associated with an identifier may be coupled to the printed media 130. Each identifier (associated with a corresponding asset tag 132) can correspond to a respective set of digital media 152. In some embodiments, the printed media 130, asset tag 132 on the printed media 130, and the corresponding subset of digital media 152 can correspond to a specific user account and/or to a specific category (e.g., period of time, location, event, user selection, etc.). In some embodiments, the subset of digital media 152 that corresponds to the identifier includes static digital media 154 of the photos printed in the printed media 130 and additional digital media (e.g., static digital media 154 and/or non-static digital media 156) associated with the static digital media 154 of the photos printed in the printed media 130 (e.g., from the same period of time, location, event, user selection, etc. as the photos printed in the printed media 130).

The asset tag 132 can be an electronic tag that is to communicate identification information (e.g., identifier) to media-associating device 110 for retrieval of digital media 152 for presentation via display 120. In some embodiments, the asset tag 132 is an NFC tag. In some embodiments, the asset tag 132 can be an RFID tag. The asset tag 132 can allow small amounts of data (e.g., identifier) to be communicated with the media-associating device 110 over a short range. The identifier can be transmitted to the media-associating device 110 by bringing the printed media 130 and the media-associating device 110 within close range and/or by tapping the printed media 130 on the media-associating device 110.

In some embodiments, the asset tag 132 is produced separate from the printed media 130 and the asset tag 132 is subsequently affixed (e.g., adhered) to the printed media 130. For example, the asset tag 132 may be a sticker (e.g., NFC sticker, RFID sticker) that is adhered to the printed media 130 (e.g., to the cover of a photo book, to the back of prints, etc.). The asset tag 132 can be affixed to a surface of the printed media 130 (e.g., on the cover of a photo book, on the inside of the cover of the photo book, on a rear surface of a printed photo, etc.). In some embodiments, the printed media 130 is produced with the asset tag 132 integral to (e.g., embedded within) the printed media 130. For example, the printed media 130 may be produced with an NFC or RFID tag within the cover (e.g., embedded in the cover of a photo book). In some embodiments, the asset tag 132 is printed directly on a surface of the printed media 130 or is printed on a separate item and the separate item is secured to the printed media 130.

The system 100 can include a server 140 coupled to a data store 150. The media-associating device 110 (e.g., via CPU 114) and the server 140 can be communicably coupled via network 160.

Network 160 can be a public network that provides user media-associating device 110 with access to server 140 and other publically available computing devices. Network 160 can include one or more wide area networks (WANs), local area networks (LANs), wired networks (e.g., Ethernet network), wireless networks (e.g., an 802.11 network or a Wi-Fi network), cellular networks (e.g., a Long Term Evolution (LTE) network), routers, hubs, switches, server computers, and/or a combination thereof. Network 160 can use standard internet protocol used by mobile devices and connected computers.

Server 140 can be one or more computing devices (such as a rackmount server, a router computer, a server computer, a personal computer, a mainframe computer, a laptop computer, a tablet computer, a desktop computer, etc.), data stores (e.g., hard disks, memories, databases, etc.), networks, software components, and/or hardware components. Server 140 can manage digital media 152 stored in data store 150. Server 140 can receive digital media 152 uploaded by users. In some embodiments, server 140 can assign subsets of digital media 152 to collections (e.g., to correspond to a respective identifier). Server 140 can determine (e.g., based on user input, user settings, or a portion of a collection of digital media 152) selections of photos to be printed in printed media 130 and can cause the primed media 130 to be produced. Server 140 can determine a subset of digital media 152 (e.g., the corresponding collection) that is to be associated with an identifier of an asset tag 132 attached to printed media 130. Server 140 can receive an identifier from a media-associating device 110 and can provide the respective digital media 152 (e.g., to the media-associating device 110) for presentation via display 120. Server 140 can listen to and respond to commands from CPU 114 of media-associating device 110. Server 140 can be used to provide media-associating device 110 access to digital media 152 stored in data store 150.

In some embodiments, server 140 can receive digital media 152 associated with user credentials (e.g., receive digital media 152 from a user that is logged into a user account, a user may allow access to digital media 152 to particular users). The server 140 can allow access to the digital media 152 upon receiving the user credentials (e.g., upon logging in). For example, a user may access the digital media 152 uploaded by the user and shared with the user by other users. The server 140 may provide different levels of access privileges (e.g., viewing privileges, commenting privileges, editing privileges, printing privileges, downloading privileges, playback privileges, etc.) based on user credentials. In some embodiments, the server 140 may receive user input to associate a user selection of digital media 152 (to which the user has access privileges) with an asset tag 132. For example, a user may have a photo book with an NFC sticker affixed to the photo book and the user may associate the identifier of the NFC sticker with particular non-static digital media 156. Upon tapping the photo book on a dongle (e.g., media-connecting device 110), the dongle may cause the non-static digital media 156 to be presented via the connected television.

In some embodiments, the digital media 152 associated with the identifier of the asset tag 132 is provider-selected (e.g., selected by the server 140, provider-created). In some embodiments, the digital media 152 associated with the identifier of the asset tag 132 is user-selected (e.g., server 140 receives user input selecting the digital media 152, user created). In some embodiments, the digital media 152 associated with the identifier of the asset tag 132 is a hybrid of provider-selected and user-selected (e.g., hybrid of provider-created and user-created).

Data store 150 can be a memory (e.g., random access memory), a drive (e.g., a hard drive, a flash drive), a database system, or another type of component or device capable of storing data. Data store 150 can include multiple storage components (e.g., multiple drives or multiple databases) that can span multiple computing devices (e.g., multiple server computers). The data store 150 can store digital media 152.

Digital media 152 can include digital content chosen by a user, digital content made available by a user, digital content developed by a user, digital content uploaded by a user, digital content captured by a user, digital content developed by a content provider, digital content uploaded by a content provider, digital content provided by server 140, etc. Digital media 152 can include static digital media 154 and non-static digital media 156. Static media 154 can be media that does not move with time, such as photographs, and images. Non-static digital media 156 can include videos, live photos (e.g., a short video captured alongside each photo taken, additional frames captured before and/or after each photo taken), slideshows, media with metadata (e.g., captions, etc.), media with audio, augmented reality (AR) experiences, virtual reality (VR) experiences, media that moves with time (e.g., dynamic media), three-dimensional (3D) models, 360-degree videos, games, advertisements, and so forth. The digital media 152 can include electronic files (e.g., digital media files, static digital media files, non-static digital media files) that can be executed or loaded using software, firmware, or hardware configured to present the digital media 152.

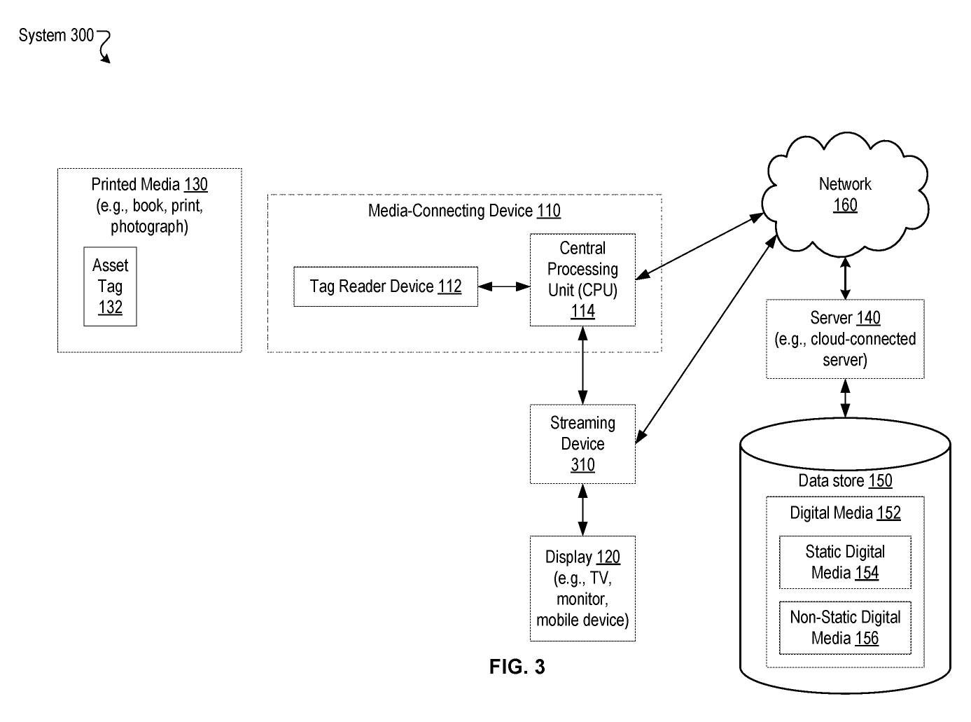

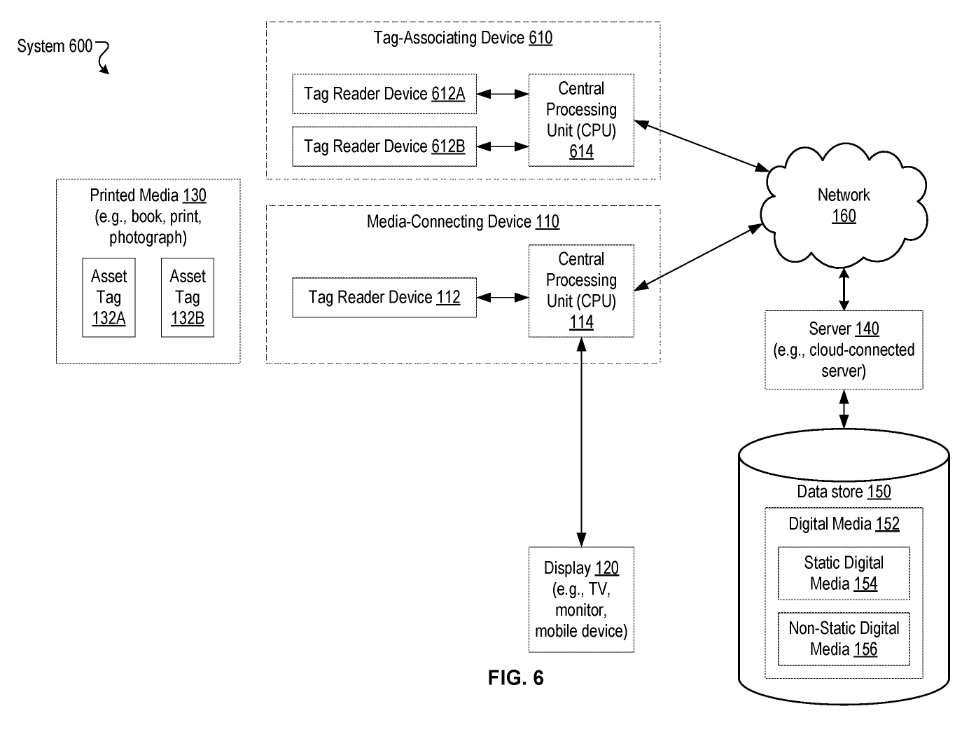

In general, functions described in one embodiment as being performed by CPU 114 can be performed by server 140, streaming device 310 of FIG. 3, or tag-associating device 610 of FIG. 6, in other embodiments as appropriate. Functions described in one embodiment as being performed by server 140 can be performed by media-associating device 110, data store 150, streaming device 310 of FIG. 3, or tag-associating device 610 of FIG. 6, in other embodiments, as appropriate. In addition, the functionality attributed to a particular component can be performed by different or multiple components operating together. The server 140 can also be accessed as a service provided to other systems or devices through appropriate application programming interfaces (APIs).

In implementations of the disclosure, a “user” can be represented as a single individual. However, other implementations of the disclosure encompass a “user” being an entity controlled by a set of users and/or an automated source. For example, a set of individual users federated as a community in a social network can be considered a “user.” In another example, an automated consumer can be an automated ingestion pipeline of the application distribution platform.

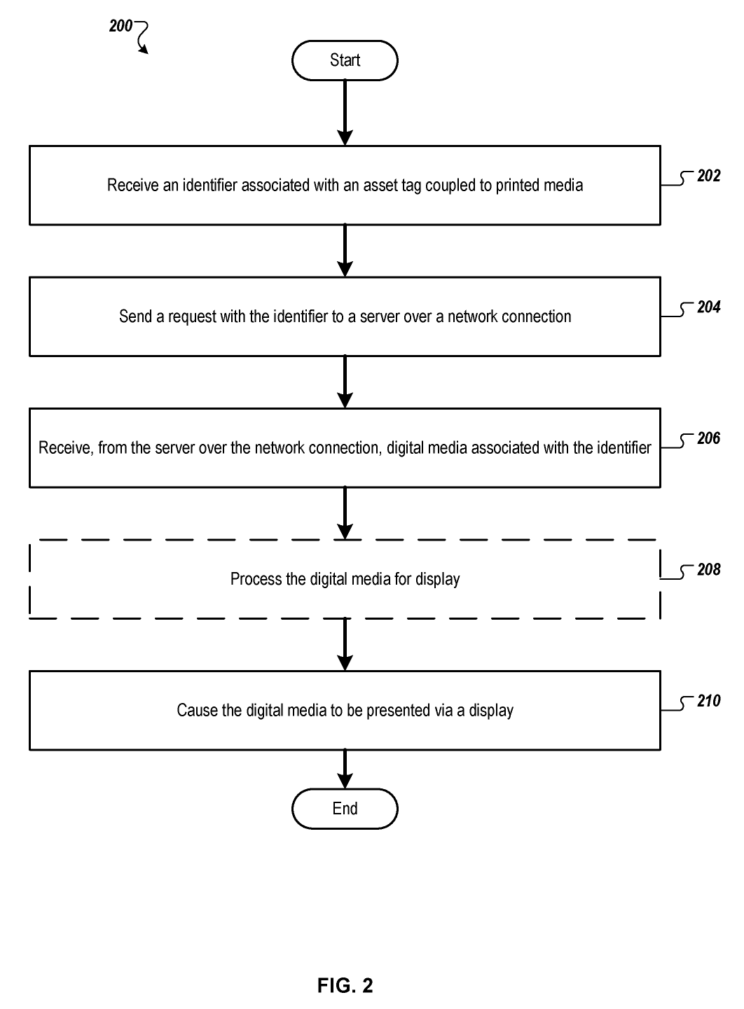

FIG. 2 is a flow diagram of a method 200 for using a media-associating device 110 with printed media 130 for playback of digital media 152 (e.g., non-static digital media 156), according to certain embodiments.

The method 200 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 200 is performed by the system 100 of FIG. 1. In some embodiments, the method 200 is performed by media-associating device 110 of FIG. 1. In some embodiments, method 200 is performed by CPU 114 of FIG. 1. In some embodiments, method 200 is performed by a processing device of the system 100 or media-associating device 110 (e.g., a non-transitory computer-readable storage medium comprising instructions that when executed by a processing device cause the processing device to perform method 200). In some embodiments, one or more portions of method 200 is performed by one or more other components (e.g., server 140, etc.).

Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

Referring to FIG. 2, the method 200 begins at block 202 by the processing logic receiving an identifier associated with an asset tag 132 coupled to printed media 130. In some embodiments, the tag reader device 112 (e.g., NFC reader device, RFID reader device) reads the identifier (e.g., UID) from the asset tag 132 (e.g., NFC tag, RFID tag). The tag reader device 112 can transmit the identifier to the CPU 114.

At block 204, the processing logic transmits the identifier via network 160 to the server 140 to cause the server 140 to retrieve digital media 152 (e.g., non-static digital media 156) associated with the identifier from a data store 150. For example, the CPU 114 can send the identifier through the network 160 to the server 140 and upon receiving the identifier, the server 140 can attempt to match the identifier to a collection of digital media 152. Server 140 can generate collections of similar digital media 152 as digital media 152 is uploaded, as printed media 130 are produced, responsive to user input, responsive to identifying a threshold amount of digital media 152 that are similar to each other, etc. The server 140 can retrieve the digital media 152 from the data store 150 and the server 140 can send the digital media 152 through the network 160 to the CPU 114.

At block 206, the processing logic receives the digital media 152 via the network 160 from the server 140. The processing logic can store the digital media 152 (e.g., in local storage of media-associating device 110).

At block 208, the processing logic processes the digital media 152 for display. For example, the CPU 114 can process the digital media 152 to be displayed via a slideshow, video playback (e.g., playback of a series of digital media 152), media with metadata (e.g., captions, etc.), AR and/or VR experiences, or other video display techniques. In some embodiments, the processing logic can determine playback parameters (e.g., order, transitions, audio, quality, speed, cropped, size, etc.) of the digital media 152 and apply the playback parameters to the digital media 152.

At block 210, the processing logic causes the digital media 152 to be displayed via display 120. In some embodiments, the processing logic streams the digital media 152 from the server 140 to the display 120.

FIG. 3 is a block diagram of a system 300 including a media-associating device 110 (e.g., IoT device, IoT-connected device, electronic device, etc.) and a streaming device 310, according to certain embodiments.

The media-associating device 110 can employ a standalone tag reader device 112 (e.g., standalone NFC reader) and CPU 114 that connect directly to the server 140. In some embodiments, the media-associating device 110 communicates with the server 140 via the network 160 (e.g., without communicating with streaming device 310). In some embodiments, the media-associating device 110 communicates with the streaming device 310 (e.g., without communicating with server 140). The media-associating device 110 may not communicate directly with the display 120.

A streaming device 310 can be coupled (e.g., physically connected, network connected) to the display 120 and network 160. The streaming device 310 can access digital media 152 via the network 160 and present the digital media 152 on the display 120.

The streaming device 310 can be one or more of a network-connected television device (“smart TV”), a smart TV chip, network-connected media player (e.g., Blu-ray player), a set-top-box, over-the-top (OTT) streaming device, operator box, personal computer (PC), laptop, mobile phone, smart phone, tablet computer, netbook computer, digital media player, micro console, small network appliance, entertainment device that receives and streams digital data to display 120, receiver box, a HDMI plug-in stick, a USB plug-in stick, a dongle, etc. In some embodiments, the streaming device 310 can physically connect to a port (e.g., USB or HDMI port) of display 120. In some embodiments, the streaming device 310 can wirelessly connect to the display 120. In some embodiments, the streaming device 310 is integral to the display 120. For example display 120 can be a smart TV and streaming device 310 can be processing logic integral to the smart television that executes a smart TV application.

In some embodiments, responsive to reading the asset tag 132 coupled to printed media 130, the media-associating device 110 can transmit the identifier associated with the asset tag 132 to the server 140. In some embodiments, responsive to reading the asset tag 132 coupled to printed media 130, the media-associating device 110 can transmit the identifier associated with the asset tag 132 to the streaming device 310 and the streaming device 310 can transmit the identifier to the server 140. The streaming device 310 can be coupled to the server 140 and/or media-associating device 110 via the network 160.

The server 140 can retrieve digital media 152 associated with the identifier from the data store 150. In some embodiments, the media-associating device 110 can receive the digital media 152, process the digital media 152, and transmit the digital media 152 to the streaming device 310. The streaming device 310 can cause the display 120 to display the digital media 152. In some embodiments, the media-associating device 110 may not receive the digital media 152 from the server 140. The streaming device 310 can receive the digital media 152 from the server 140 (e.g., directly from the server 140) via network 160. In some embodiments, the streaming device 310 processes the digital media 152 and causes the display 120 to present the digital media 152. In some embodiments, the streaming device 310 provides the digital media 152 to the media-associating device 110, the media-associating device 110 processes the digital media 152 and transmits the digital media 152 to the streaming device 310, and the streaming device 310 causes the display 120 to present the digital media 152. The streaming device 310 and/or media-associating device 110 can have local storage to cache the digital media 152.

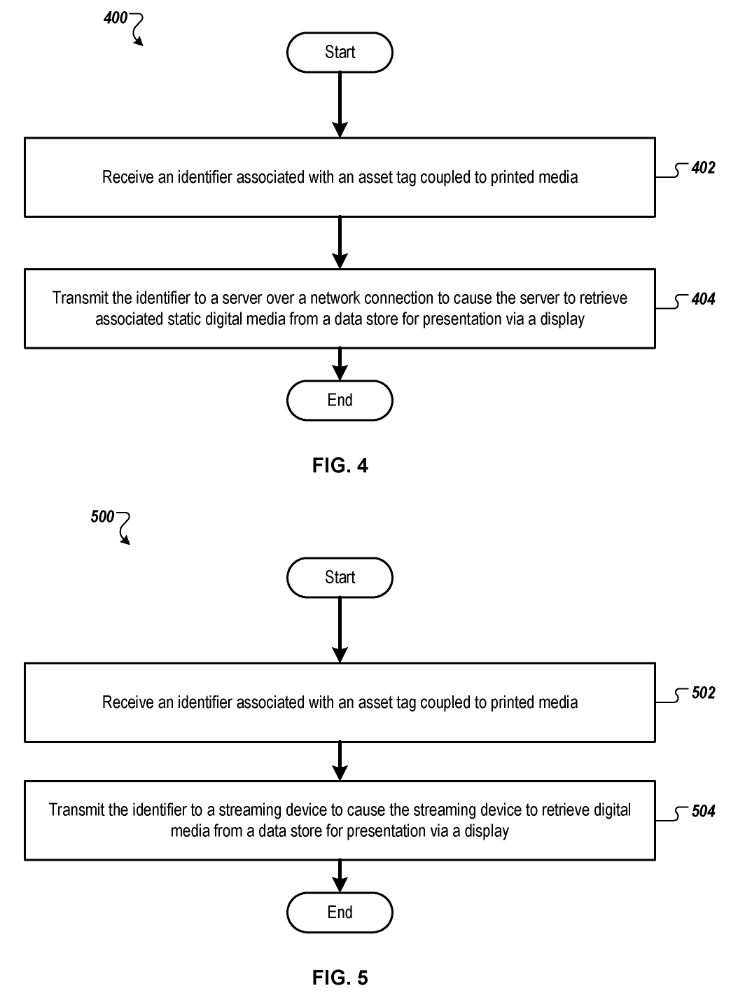

FIGS. 4-5 are flow diagrams of methods 400-500 for using a media-associating device 110 (e.g., an IoT device) with printed media 130 for playback of digital media 152, according to certain embodiments.

The methods 400-500 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the methods 400-500 are performed by the system 300 of FIG. 3. In some embodiments, the methods 400-500 are performed by media-associating device 110 of FIG. 3. In some embodiments, methods 400-500 is performed by CPU 114 of FIG. 3. In some embodiments, methods 400-500 are performed by a processing device of the system 100 and/or media-associating device 110 (e.g., a non-transitory computer-readable storage medium comprising instructions that when executed by a processing device cause the processing device to perform methods 400-500). In some embodiments, one or more portions of methods 400-500 are performed by one or more other components (e.g., server 140, streaming device 310, etc.).

Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

Referring to FIG. 4, the method 400 begins at block 402 by the processing logic receiving an identifier associated with an asset tag 132 coupled to printed media 130.

At block 404, the processing logic transmits the identifier via network 160 to the server 140 to cause the server 140 to retrieve digital media 152 associated with the identifier for presentation via display 120. The media-associating device 110 (e.g., IoT device) can be coupled to server 140 via network 160. The streaming device 310 can be coupled to the server 140 via the network 160. The media-associating device 110 may not have a direct connection to the streaming device 310. The CPU 114 can transmit the identifier via the network 160 to the server 140. The server 140 can retrieve (e.g., look up) digital media 152 from the data store 150. The server 140 can transmit the identifier to the streaming device 310 or the streaming device 310 can poll and request the last scanned identifier (e.g., from the server 140). Using the identifier, the streaming device 310 can request digital media 152 associated with the identifier from the server 140. The server 140 can transmit the digital media 152 to the streaming device 310 via network 160. The streaming device 310 can cause the digital media 152 to be presented via the display 120.

Referring to FIG. 5, the method 500 begins at block 502 by the processing logic receiving an identifier associated with an asset tag 132 on printed media 130.

At block 504, the processing logic transmits the identifier to streaming device 310 to cause the streaming device 310 to retrieve digital media 152 associated with the identifier from data store 150 (e.g., via communication with server 140 the network 160) for presentation via the display 120. The media-associating device 110 (e.g., IoT device) can connect directly (e.g., physically, via a network) to the streaming device 310 and the streaming device 310 can be coupled to the server 140 via the network 160. Upon receiving the identifier from media-associating device 110, the streaming device 310 can request digital media 152 from the server 140 using the identifier. The server can look up the digital media 152 from data store 150 and can provide the digital media 152 retrieved from the data store 150 to the streaming device 310. The streaming device 310 can cause the digital media 152 to be presented via display 120.

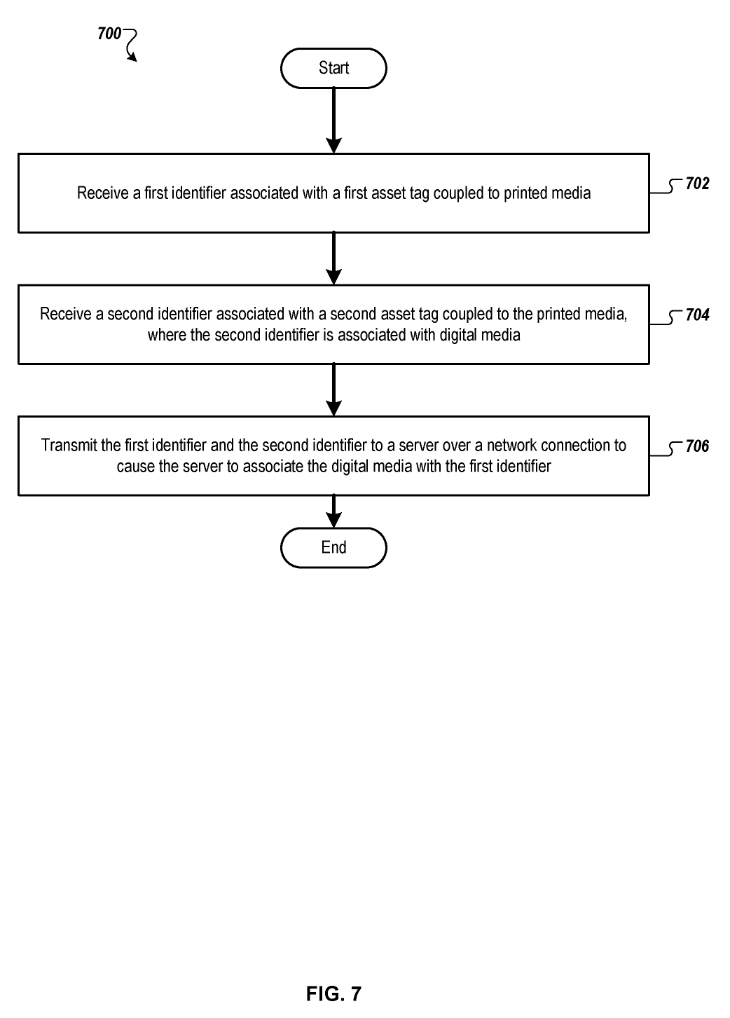

FIG. 6 is a block diagram of a system 600 including a tag-associating device 610 (e.g., electronic device), according to certain embodiments. In some embodiments, tag-associating device 610 can be used to perform one or more of method 200 of FIG. 2, method 400 of FIG. 4, method 500 of FIG. 5, and/or method 700 of FIG. 7. In some embodiments, the tag-associating device 610 and the media-connecting device 110 are the same device (e.g., CPU 114 and CPU 614 are the same CPU, tag reader device 112 and tag reader device 612A are the same tag reader device, etc.). In some embodiments, tag-associating device 610 and the media-connecting device 110 are separate devices.

The tag-associating device 610 can include a tag reader device 612A (e.g., having similar to or the same structure and/or functionalities as tag reader device 112 of FIGS. 1 and/or 3) and a CPU 614 (e.g., having similar to or the same structure and/or functionalities as CPU 114 of FIGS. 1 and/or 3). In some embodiments, tag-associating device 610 includes a tag reader device 612B (e.g., barcode reader device, optical reader device, camera and associated software, QR Code® reader device, etc.). In some embodiments, one or more of tag reader device 612A, tag reader device 612B, or CPU 614 can be part of a separate device (e.g., may not be integral to tag-associating device 610). The tag reader device 612B can be an optical reader capable of reading a code printed on the printed media 130. The CPU 614 can be a processing device capable of communicating with the tag reader device(s) 612 (e.g., NFC reader and/or barcode reader) and communicating with the server 140 via the network 160.

The printed media 130 may be coupled to asset tag 132A and asset tag 132B. Asset tag 132A may be an NFC tag, RFID tag, or other tag that may be electromagnetically read by tag reader device 612A responsive to being within a threshold distance of tag reader device 612A. Asset tag 132B may be a barcode, QR Code®, one-dimensional barcode, two-dimensional barcode, three-dimensional barcode, matrix barcode, or other type of tag that can be printed and optically read by tag reader device 6124B.

Asset tag 132A can be one or more of embedded in printed media 130, affixed to printed media 130, integral to printed media 130, in a separate component that is affixed to printed media 130, etc. printed media 130. Asset tag 132B can be one or more of printed directly on printed media 130, printed on a separate component that is affixed to printed media 130, etc.

In some embodiments, a first identifier associated with the asset tag 132A may be read by tag reader device 612A using electromagnetic fields. In some embodiments, a second identifier associated with asset tag 132B may be read optically by tag reader device 612B (e.g., using a camera and associated software).

In some embodiments the static images in printed media 130 are from a collection of digital media 152 (in data store 150) that includes static digital media 154 and non-static digital media 156. During production of the printed media 130, an asset tag 132B (e.g., barcode) may be printed on the printed media 130. By optically scanning the asset tag 132B, second identifier may be identified that is associated with the collection of digital media 152 (e.g., including non-static digital media 156) in data store 150.

In some embodiments, the asset tag 132A (e.g., NFC sticker) coupled (e.g., affixed, adhered, etc.) to the printed media 130 and initially is not associated with any digital media.

The tag-associating device 610 may receive a first identifier (e.g., UID) of asset tag 132A (e.g., via tag reader device 612A, electromagnetically) and may receive a second identifier (e.g., code) of asset tag 132B (e.g., via tag reader device 612B, optically). The second identifier may be associated with a set of digital media 152 (e.g., including non-static digital media 156). The tag-associating device 610 may transmit the first identifier and the second identifier to the server 140 to associate the first identifier with the set of digital media 152 (associated with the second identifier). By associating the first identifier of the asset tag 132A (e.g., NFC sticker) with the set of digital media 152, the digital media 152 may be accessed and presented by bringing the printed media 130 within a threshold range of the dongle (e.g., media-connecting device, electromagnetically obtaining the first identifier). The digital media 152 may be accessed and presented by electromagnetically obtaining the first identifier without optically obtaining the second identifier.

In some embodiments, the tag-associating device 610 can be used to connect printed media 130 with digital media 152 during printing and/or production of printed media 130 (e.g., printing photo books, printing photos, attaching asset tag 132, etc.). For example, responsive to asset tag 132A (e.g., NFC sticker) being affixed to printed media 130 and asset tag 132B (e.g., barcode) being printed on printed media 130, tag-associating device 610 may be used to read the identifiers from asset tags 132A-B and cause the first identifier of asset tag 132A to be associated the digital media 152 (that is associated with the second identifier of asset tag 132B). In some embodiments, the tag-associating device 610 can be used to connect printed media 130 with digital media 152 after printing/production of printed media 130. For example, a user device may access server 140 to make a selection of one or more items of digital media 152 (e.g., non-static digital media 156) and may request an asset tag 132B (e.g., barcode) associated with the selection. The server 140 may provide asset tag 132B (e.g., by causing the barcode to be displayed via the graphical user interface (GUI) of the user device, by causing the barcode to be printed, by causing the barcode to be transmitted to the user, etc.). The tag-associating device 610 can read the second identifier from the asset tag 132B received from the server 140 (e.g., by optically scanning the barcode on the screen, by optically scanning the printed barcode, etc.), read the first identifier from the asset tag 132A (e.g., by being within a threshold distance of the printed media 130), and transmit the first and second identifiers to the server 140.

In some embodiments, tag reader device 612A and tag reader device 612B are one single tag reader device 612. In some embodiments, tag reader device 612A and tag reader device 612B are separate tag reader devices.

In some embodiments, the first identifier associated with the asset tag 132A and the second identifier associated with the asset tag 132B can be associated with each other and stored in a database (e.g., of data store 150). The first and second identifiers being associated with each other in the database can allow for the server 140 to retrieve the digital media 152 corresponding to the first identifier (e.g., method 200 of FIG. 2, method 400 of FIG. 4, and method 500 of FIG. 5).

In some embodiments, the first identifier associated with the asset tag 132A and the digital media 152 associated with the second identifier (associated with the asset tag 132B) can be associated with each other and stored in a database (e.g., of data store 150). The first identifier and digital media 152 being associated with each other in the database can allow for the server 140 to retrieve the digital media 152 corresponding to the first identifier (e.g., method 200 of FIG. 2, method 400 of FIG. 4, and method 500 of FIG. 5).

The server 140 can be a computer that is connected to the network 160 and the server can be capable of receiving (e.g., listening to) and responding to commands from the CPU 614 and CPU 114. The server 140 can provide a connection to a data store 150. The data store 150 can store a database of identifiers that are associated with respective sets of digital media 152.

FIG. 7 is a flow diagram of a method 700 for using a tag-associating device 610 to associate an identifier of an asset tag with digital media 152, according to certain embodiments.

The method 700 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 700 is performed by the system 600 of FIG. 6. In some embodiments, the method 700 is performed by tag-associating device 610 of FIG. 6. In some embodiments, method 700 is performed by CPU 614 of FIG. 6. In some embodiments, method 700 is performed by a processing device of the system 600 or tag-associating device 610 (e.g., a non-transitory computer-readable storage medium comprising instructions that when executed by a processing device cause the processing device to perform method 700). In some embodiments, one or more portions of method 700 is performed by one or more other components (e.g., server 140, etc.).

Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

Referring to FIG. 7, the method 700 begins at block 702 by the processing logic receiving a first identifier associated with an asset tag 132A coupled to printed media 130. The tag reader device 612A (e.g., NFC reader device) can read (e.g., electromagnetically read) the first identifier from the asset tag 132A coupled to the printed media 130 and the tag reader device 612A can transmit the identifier to the CPU 614.

At block 704, the processing logic receives a second identifier associated with an asset tag 132B coupled to printed media 130. The second identifier is associated with digital media 152 (e.g., non-static digital media 156). The tag reader device 612B can optically read the asset tag 132B (e.g., barcode, etc.) from the printed media 130. In some embodiments, the tag reader device 612B can determine the second identifier associated with the asset tag 132B and can transmit the second identifier to the CPU 614. In some embodiments, the tag reader device 612B can transmit an image of the asset tag 132B to the CPU 614 and the CPU 614 can determine the second identifier associated with the asset tag 132B.

At block 706, the processing logic transmits the first identifier and the second identifier to the server 140 to cause the server 140 to associate the first identifier with the digital media 152 (in the data store 150). By associating the first identifier of the asset tag 132A with the digital media 152, the digital media 152 can be accessed using media-associating device 110 and/or tag-associating device 610 with asset tag 132A (without re-scanning the asset tag 132B). The data store 150 can store a database of identifiers and digital media 152 for easily lookup responsive to a playback request using the asset tag 132A.

In some embodiments, a trained machine learning model (e.g., machine learning algorithm) can be used to organize and curate a set of media (e.g., digital media 152, static digital media 154, non-static digital media 156) into a media presentation (e.g., selecting digital media 152, such as non-static digital media 156, for playback). The trained machine learning model can also be used to curate which digital media 152 (e.g., non-static digital media 156) is associated with the printed media 130. For example, a machine learning model can receive training data that includes training input and target output. The training input can be a representation of media (e.g., printed media 130, digital media 152) of a user. For example, the training input can include digital media 152 of a user that is uploaded to the data store 150. In another example, the training input can include digital media 152 of a user that is uploaded to the data store 150 and that is associated with a time frame (e.g., digital media 152 captured during a period of time, digital media 152 uploaded during a period of time). In another example, the training input can include digital media 152 of a user that is uploaded to the data store 150 and that is associated with a location (e.g., digital media 152 captured from a location, digital media 152 uploaded from a location). In another example, the training input can include digital media 152 of a user that is uploaded to the data store 150 and that is in a particular category (e.g., digital media 152 that has received an approval such as a “like” or rating, that has been commented on, or that has been shared). In some embodiments, the target output can be a subset of the digital media 152 that was associated with the identifier of the asset tag 132 coupled to the printed media 130). In some embodiments, the target output can be a subset of the digital media 152 that was used to make a media presentation (e.g., a media presentation to be associated with the identifier of the asset tag 132 coupled to the printed media 130). In some embodiments, the target output includes one or more of the order of the digital media 152 in the media presentation, the transitions of the digital media 152 in the media presentation, the speed of the media presentation, audio of the media presentation, etc. The training data can be used to train the machine learning model to generate a trained machine learning model.

Digital media 152 of a user (e.g., associated with a time frame, location, category, approval rating, etc.) can be input into the trained machine learning model and the output can be obtained from the trained machine learning model. In some embodiments, the output can include an indication a subset of the digital media 152 that is to be associated with the identifier of the asset tag 132 on the printed media 130. In some embodiments, the output can include an indication of one or more properties (e.g., subset of the digital media 152, transitions, speed, audio, etc.) of a media presentation that is to be associated with the identifier of the asset tag 132 on the printed media 130. In some embodiments, the output can include a media presentation including a subset of the digital media 152.

A trained machine learning model can be used to present playback of digital media 152 (e.g., non-static digital media 156). The trained machine learning model can include algorithms to one or more of select the best clip of a long video for playback, detect which parts of an image can be safely cropped during playback, identify key components (e.g., geolocation and time) of digital media 152 to allow for a better playback experience, or select music and them to match the content. The training input can include digital media 152 associated with a user account and metadata associated with the digital media 152 (e.g., timestamp, geolocation, length of media item, etc.). The target output can be a media presentation based on a subset of the digital media 152 (e.g., selected clips of media, cropping of the digital media 152, selected music, selected theme, etc.). A machine learning model can be trained using the training input and target output to generate a trained machine learning model. Digital media 152 of a user (e.g., corresponding to a period of time, location, etc.) can be input into the trained machine learning model and a media presentation (e.g., with selected clips of media, cropping of the digital media 152, selected music, selected theme) can be generated based on the output of the trained machine learning model.

In some embodiments, the printed media 130 is a greeting card. A greeting card can include an asset tag 132A (e.g., NFC tag, RFID tag) and/or an asset tag 132B (e.g., barcode). Digital media 152 (e.g., non-static digital media 156) can be associated with the first identifier of the asset tag 132A and/or the second identifier of the asset tag 132B. A media-associating device 110 or tag-associating device 610 can read the asset tag 132A and/or 132B to cause digital media 152 (e.g., an associated video) to be presented to the recipient of the greeting card.

In some embodiments, media-associating device 110 and/or tag-associating device 610 can be used to associate an ad campaign or a brand campaign to a media presentation (e.g., non-static digital media presentation, video presentation, etc.). Asset tags 132 can be placed in printed or static media (e.g., printed advertisements, static advertisements). The media-associating device 110 can be used to connect to and cause playback of content associated with the printed campaign.

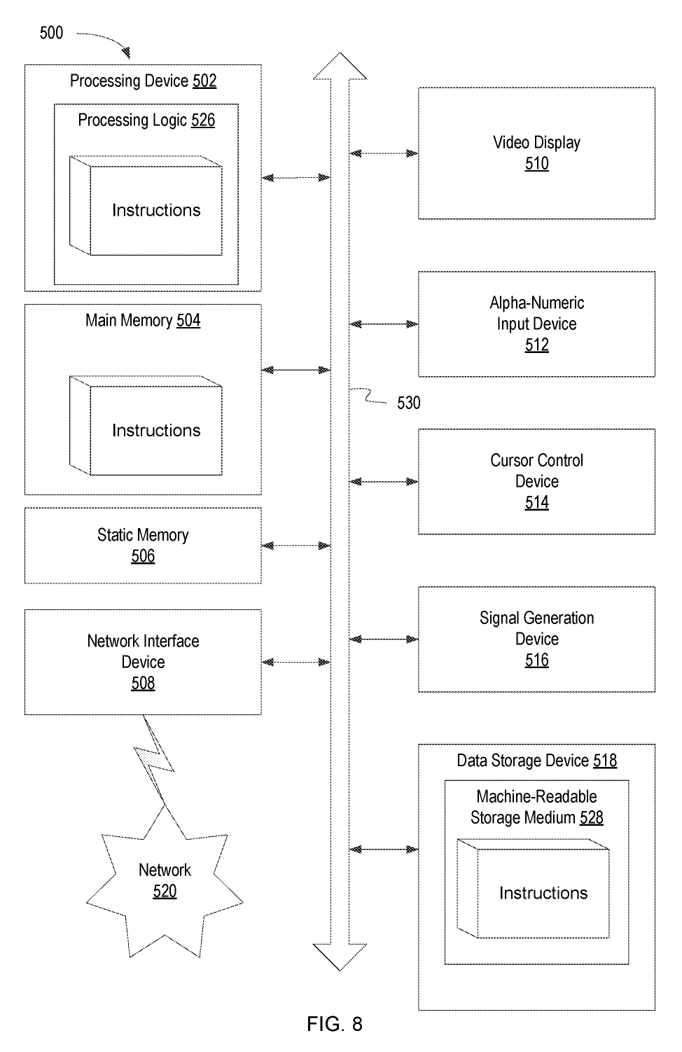

FIG. 8 illustrates a diagrammatic representation of a machine in the example form of a computer system including a set of instructions executable by a computer system 800 according to any one or more of the methodologies discussed herein. In some embodiments, computer system 800 includes one or more components of system 100 of FIG. 1, system 300 of FIG. 3, or system 600 of FIG. 6 (e.g., media-associating device 110, tag-associating device 610, etc.). The computer system 800 can have more or less components than those shown in FIG. 8 (e.g., media-associating device 110 and/or tag-associating device 610 can have more or fewer components than shown in computer system 800). In one embodiment, the computer system can include instructions to enable execution of the processes and corresponding components shown and described in connection with FIGS. 1-7.

In alternative embodiments, the machine can be connected (e.g., networked) to other machines in a LAN, an intranet, an extranet, or the Internet. The machine can operate in the capacity of a server machine in a client-server network environment. The machine can be a personal computer (PC), a set-top box (STB), a server, a network router, switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

In some embodiments, the example computer system 800 includes a processing device (e.g., processor, CPU, etc.) 802, a main memory 804 (e.g., read-only memory (ROM), flash memory, dynamic random access memory (DRAM) such as synchronous DRAM (SDRAM)), a static memory 806 (e.g., flash memory, static random access memory (SRAM)), and a data storage device 818, which communicate with each other via a bus 830. In some embodiments, memory (e.g., main memory 804, data storage device 818, etc.) can be spread across one or more mediums (e.g., of an on-demand cloud computing platform).

Processing device 802 represents one or more general-purpose processing devices such as a microprocessor, central processing unit, or the like. More particularly, the processing device 802 can be a complex instruction set computing (CISC) microprocessor, reduced instruction set computing (RISC) microprocessor, very long instruction word (VLIW) microprocessor, or a processor implementing other instruction sets or processors implementing a combination of instruction sets. The processing device 802 can also be one or more special-purpose processing devices such as an application specific integrated circuit (ASIC), a field programmable gate array (FPGA), a digital signal processor (DSP), network processor, or the like. In various implementations of the present disclosure, the processing device 802 is configured to execute instructions for performing the operations and processes described herein (e.g., method 200 of FIG. 2, 400 of FIG. 4, 500 of FIG. 5, 700 of FIG. 7, etc.).

The computer system 800 can further include a network interface device 808. The computer system 800 also can include a video display unit 810 (e.g., a liquid crystal display (LCD) or a cathode ray tube (CRT)), an alphanumeric input device 812 (e.g., a keyboard), a cursor control device 814 (e.g., a mouse), and a signal generation device 816 (e.g., a speaker).

The data storage device 818 can include a computer-readable storage medium 828 (or machine-readable medium) on which is stored one or more sets of instructions embodying any one or more of the methodologies or functions described herein. The instructions can also reside, completely or at least partially, within the main memory 804 and/or within processing logic 826 of the processing device 802 during execution thereof by the computer system 800, the main memory 804 and the processing device 802 also constituting computer-readable media.

The instructions can further be transmitted or received over a network 820 via the network interface device 808. While the computer-readable storage medium 828 is shown in an example embodiment to be a single medium, the term “computer-readable storage medium” should be taken to include a single medium or multiple media (e.g., a centralized or distributed database, and/or associated caches and servers) that store the one or more sets of instructions. The term “computer-readable storage medium” shall also be taken to include any medium that is capable of storing, encoding or carrying a set of instructions for execution by the machine and that cause the machine to perform any one or more of the methodologies of the present disclosure. The term “computer-readable storage medium” shall accordingly be taken to include, but not be limited to, solid-state memories, optical media, and magnetic media.

The preceding description sets forth numerous specific details such as examples of specific systems, components, methods, and so forth, in order to provide a good understanding of several embodiments of the present disclosure. It will be apparent to one skilled in the art, however, that at least some embodiments of the present disclosure can be practiced without these specific details. In other instances, well-known components or methods are not described in detail or are presented in simple block diagram format in order to avoid unnecessarily obscuring the present disclosure. Thus, the specific details set forth are merely presented as examples. Particular implementations can vary from these example details and still be contemplated to be within the scope of the present disclosure. In the above description, numerous details are set forth.

It will be apparent, however, to one of ordinary skill in the art having the benefit of this disclosure, that embodiments of the disclosure can be practiced without these specific details. In some instances, well-known structures and devices are shown in block diagram form, rather than in detail, in order to avoid obscuring the description.

Some portions of the detailed description are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to the desired result. The steps are those requiring physical manipulations of physical quantities. Usually, though not necessarily, these quantities take the form of electrical, magnetic, or optical signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “reading,” “sending,” “receiving,” “outputting,” “preparing,” “causing,” “transmitting,” or the like, refer to the actions and processes of a computer system, or similar electronic computing device, that manipulates and transforms data represented as physical (e.g., electronic) quantities within the computer system's registers and memories into other data similarly represented as physical quantities within the computer system memories or registers or other such information storage, transmission or display devices.

Embodiments of the disclosure also relate to an apparatus for performing the operations herein. This apparatus can be specially constructed for the required purposes, or it can comprise a general purpose computer selectively activated or reconfigured by a computer program stored in the computer. Such a computer program can be stored in a computer-readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions.

The algorithms and displays presented herein are not inherently related to any particular computer or other apparatus. Various general-purpose systems can be used with programs in accordance with the teachings herein, or it can prove convenient to construct a more specialized apparatus to perform the required method steps. The required structure for a variety of these systems will appear from the description below. In addition, the present embodiments are not described with reference to any particular programming language. It will be appreciated that a variety of programming languages can be used to implement the teachings of the present disclosure as described herein. It should also be noted that the terms “when” or the phrase “in response to,” as used herein, should be understood to indicate that there can be intervening time, intervening events, or both before the identified operation is performed.

It is to be understood that the above description is intended to be illustrative, and not restrictive. Many other embodiments will be apparent to those of skill in the art upon reading and understanding the above description. The scope of the disclosure should, therefore, be determined with reference to the appended claims, along with the full scope of equivalents to which such claims are entitled.

What is claimed is:

1. An electronic device comprising:
a tag reader device to read a unique identifier (UID) from an asset tag coupled to a printed product; and
a central processing unit (CPU) coupled to the tag reader device, wherein the CPU is to:
send a request with the UID to a server over a network connection;
receive, from the server over the network connection, a response comprising non-static digital media associated with the UID; and
cause the non-static digital media to be presented via a display.

2. The electronic device of claim 1, wherein the tag reader device is a radio-frequency identification (RFID) tag reader device and the asset tag is an RFID tag.

3. The electronic device of claim 1, wherein the tag reader device is a near-field communication (NFC) tag reader device and the asset tag is an NFC tag.

4. The electronic device of claim 1, wherein the non-static digital media comprises at least one of a video, a live photograph, or a three-dimensional (3D) model.

5. The electronic device of claim 1, wherein to cause the non-static digital media to be presented via the display, the CPU is further to prepare a presentation comprising the non-static digital media.

6. The electronic device of claim 5, wherein the presentation comprises at least one of a slideshow, a video playback, metadata associated with the UID, an augmented reality (AR) experience, or a virtual reality (VR) experience.

7. A method comprising:
reading a first identifier from a first asset tag coupled to a printed product using a first tag reader device;
sending a request with the first identifier to a server over a network connection;
receiving, from the server over the network connection, a response comprising non-static digital media associated with the first identifier; and
causing the non-static digital media to be presented via a display.

8. The method of claim 7 further comprising:
reading a second identifier from a second asset tag coupled to the printed product, wherein the second identifier is associated with the non-static digital media; and
transmit the first identifier and the second identifier to the server to cause the server to associate the non-static digital media with the first identifier.

9. The method of claim 8, wherein:
the second asset tag is a barcode printed on the printed product; and
the reading of the second identifier from the second asset tag comprises optically reading the barcode using an optical reader device.

10. The method of claim 8, wherein:
the first asset tag is a radio-frequency identification (RFID) tag; and
the reading of the first identifier from the first asset tag comprises using an RFID tag reader device to read the RFID tag.

11. The method of claim 8, wherein:
the first asset tag is a near-field communication (NFC) tag; and
the reading of the first identifier from the first asset tag comprises using an NFC tag reader device to read the NFC tag.

12. The method of claim 7, wherein the non-static digital media comprises at least one of a video, a live photograph, or a three-dimensional (3D) model.

13. The method of claim 7, wherein causing the non-static digital media to be presented via the display comprises preparing a presentation comprising the non-static digital media.

14. The method of claim 13, wherein the presentation comprises at least one of a slideshow, a video playback, metadata associated with the first identifier, an augmented reality (AR) experience, or a virtual reality (VR) experience.

15. A system comprising:
printed media coupled to a first asset tag; and
a first electronic device comprising:
a first tag reader device to read a first identifier from the first asset tag;
a central processing unit (CPU) coupled to the first tag reader device, wherein the CPU is to:
send a request with the first identifier to a server over a network connection;
receive, from the server over the network connection, a response comprising non-static digital media associated with the first identifier; and
cause the non-static digital media to be presented via a display.

16. The system of claim 15 further comprising:
a second electronic device to:
read the first identifier from the first asset tag;
read a second identifier from a second asset tag coupled to the printed media, wherein the second identifier is associated with the non-static digital media; and
transmit the first identifier and the second identifier to the server to cause the server is to associate the non-static digital media with the first identifier.

17. The system of claim 16, wherein the first electronic device and the second electronic device are a same electronic device.

18. The system of claim 16, wherein:
the second electronic device is to read the second identifier from the second asset tag using an optical reader device of the second electronic device; and
the second asset tag is a barcode printed on the printed media.

19. The system of claim 18, wherein the first tag reader device is a radio-frequency identification (RFID) tag reader device and the first asset tag is an RFID tag.

20. The system of claim 18, wherein the first tag reader device is a near-field communication (NFC) tag reader device and the first asset tag is an NFC tag.
